(19) United States
(12) Patent Application Publication
(10) Pub. No.: US 2018/0013958 A1
(43) Pub. Date: Jan. 11, 2018

(54) IMAGE CAPTURING APPARATUS, CONTROL METHOD FOR THE IMAGE CAPTURING APPARATUS, AND RECORDING MEDIUM

(71) Applicant: CANON KABUSHIKI KAISHA, Tokyo (JP)

(72) Inventor: Shota Nakata, Kawasaki-shi (JP)

(21) Appl. No.: 15/622,973

(22) Filed: Jun. 14, 2017

(30) Foreign Application Priority Data
Jul. 6, 2016 (JP) 2016-134484

(51) Int. Cl. H04N 5/232; G06T 5/20; G06T 3/40

(52) U.S. Cl. CPC H04N 5/23296; G06T 3/4038; G06T 5/20

(57) ABSTRACT

An image capturing apparatus includes a setting unit and an extension unit. The setting unit sets a range of a restricted area where browsing is restricted in an image captured by an image capturing unit that captures an image formed by a lens. The extension unit extends a size of the restricted area with respect to a real space in a manner that browsing of a second area in the real space, which includes a first area and also is wider than the first area, is restricted in a case where the restricted area where browsing of the first area in the real space is restricted is set by the setting unit and also an image capturing area where image capturing can be executed by the image capturing unit is extended.

### BACKGROUND OF THE INVENTION

Field of the Invention

The present disclosure relates to an image capturing apparatus, a control method for the image capturing apparatus, and a recording medium.

Description of the Related Art

In recent years, a monitoring camera system using a network has been widely spread.

Monitoring cameras have been used in a wide range of fields such as large-scale public institution and mass retailers, and various operation methods have been proposed. A monitoring camera having various functional features to be adapted to the operation method exists. For example, a monitoring camera that can freely change an imaging direction such as panning and tilting, a monitoring camera that can perform zoom imaging at a high magnification although the imaging direction is not changeable, and the like exist. Among those monitoring cameras, a monitoring camera with interchangeable lenses in which a lens can be replaced with one adapted to an environment of a user exists. A mount unit that mounts the lens to a monitoring camera main body is provided in the monitoring camera with the interchangeable lenses, and the lens fit to the mount unit is mounted to be used. At this time, as a shape of the mount unit, not only a dedicated-use lens for the monitoring camera but also a mount unit common to a lens used for a single-lens reflex camera or the like may be used. In the above-described case, since the lens for the single-lens reflex camera used by a consumer user can also be mounted to the monitoring camera, a range for the user to choose the lens is widened, and it is possible to perform the imaging adapted to various scenes.

In the operation of the monitoring camera, a use case exists where individual privacy is taken into account and a particular area should be invisible in a case where the monitoring camera is installed in a public area or an outdoor location. To address this use case, a technology called a privacy mask for masking the particular area has been proposed (for example, see Japanese Patent Laid-Open No. 2009-135683).

In addition, a technology for appropriately tracking the mask area even in a case where panning, tilting, zooming, or the like is executed has been proposed (for example, Japanese Patent Laid-Open No. 2014-239390).

In a case where the monitoring camera according to the above-described related art technology is used, since the user sets the privacy mask while a captured image of the monitoring camera is observed, the privacy mask is not set outside a capturing range of the monitoring camera. Therefore, in a case where the user desires to mask an entire area in a predetermined direction, the user sets a subject of the privacy mask up to an end of the area in the predetermined direction in the captured image of the monitoring camera.

However, in the monitoring camera with the interchangeable lenses, an image capturing area (viewing angle) corresponding to an area where image capturing is performed in a real space may be extended by replacement with a wide-angle lens or the like. When the image capturing area is extended, the extended area is not masked although the entire area in the predetermined direction should be masked.

### SUMMARY OF THE INVENTION

The following configuration is provided as an example of appropriately setting an area where browsing is restricted, even in a case where the image capturing area is extended.

According to an aspect of the present invention, an image capturing apparatus includes a setting unit configured to set a range of a restricted area where browsing is restricted in an image captured by an image capturing unit that captures an image formed by a lens, and an extension unit configured to extend a size of the restricted area with respect to a real space in a manner that browsing of a second area in the real space, which includes a first area and also is wider than the first area, is restricted in a case where the restricted area where browsing of the first area in the real space is restricted is set by the setting unit and also an image capturing area where image capturing can be executed by the image capturing unit is extended.

Further features of the present invention will become apparent from the following description of embodiments with reference to the attached drawings.

### BRIEF DESCRIPTION OF THE DRAWINGS

FIG. 1A is a conceptual diagram of a monitoring camera system, and FIG. 1B is an external appearance view of a monitoring camera.

FIG. 2 is a hardware configuration diagram of the monitoring camera system.

FIG. 3 is a functional block diagram of the monitoring camera according to a first embodiment.

FIGS. 4A to 4D are conceptual diagrams for describing various areas according to the first embodiment.

FIGS. 5A and 5B are explanatory diagrams for describing how the various areas are represented according to the first embodiment.

FIG. 6 is a flow chart of mask setting event processing according to the first embodiment.

FIG. 7 is a flow chart of restricted image generation processing according to the first embodiment.

FIG. 8 is a flow chart of lens replacement event processing according to the first embodiment.

FIG. 9A illustrates an example of a captured image according to the first embodiment.

FIG. 9B illustrates an example of a restricted image according to the first embodiment.

FIG. 9C illustrates an example of an image immediately after an image capturing executable area is extended according to the first embodiment.

FIG. 9D illustrates an example of the restricted image when the image capturing executable area is extended according to the first embodiment.

FIG. 10A illustrates an example of the restricted image for a general user according to the first embodiment.

FIG. 10B illustrates an example of the restricted image for an administrator according to the first embodiment.

FIG. 11 illustrates an example of the image capturing executable area according to the first embodiment.

FIG. 12 is a flow chart of initialization event processing according to a second embodiment.

FIG. 13 is a flow chart of the restricted image generation processing according to the second embodiment.

FIG. 14 is a flow chart of the lens replacement event processing according to the second embodiment.

FIG. 15 illustrates an example of the image capturing executable area according to the second embodiment.

FIG. 16 is a flow chart of the mask setting event processing according to a third embodiment.

FIG. 17 is a flow chart of focal length change event processing according to the third embodiment.

FIG. 18 is a flow chart of activation event processing according to a fourth embodiment.

FIG. 19 is a flow chart of the focal length change event processing according to the fourth embodiment.

FIGS. 20A to 20C illustrate examples of various areas of a stationary monitoring camera.

### DESCRIPTION OF THE EMBODIMENTS

Hereinafter, embodiments of the present invention will be described in detail with reference to the accompanying drawings. A space in reality will be referred to as a real space.

### First Embodiment

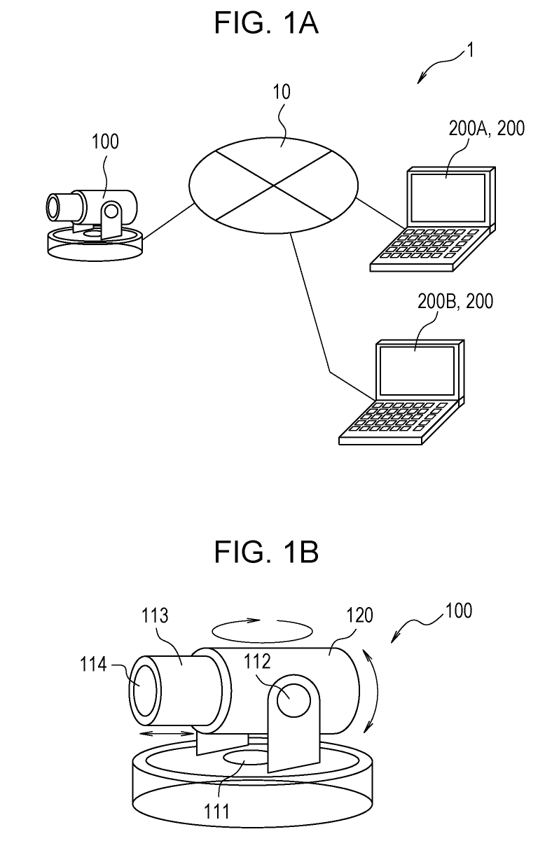

First, a monitoring camera system 1 according to the present embodiment will be described with reference to FIG. 1A. FIG. 1A is a conceptual diagram of the monitoring camera system 1. The monitoring camera system 1 is a system provided with a monitoring camera 100 corresponding to an example of an image capturing apparatus and a client apparatus 200 corresponding to an external device and configured to display an image based on the image capturing of the monitoring camera 100 on the client apparatus 200. The monitoring camera 100 and the client apparatus 200 are connected to each other via a network 10 so as to be mutually communicable.

The client apparatus 200 transmits a command for a setting of a privacy mask (hereinafter, which will be referred to as a mask) and various commands related to control of the monitoring camera 100 to the monitoring camera 100. The client apparatus 200 also displays an image received from the monitoring camera 100. The client apparatus 200 includes a client apparatus 200A for a general user and a client apparatus 200B for an administrator. The administrator is a user having a higher authority than that of the general user. A configuration may be adopted in which the client apparatus 200A for the general user does not transmit the commands to the monitoring camera 100 and only performs display of the image received from the monitoring camera 100. In addition, even the same client apparatuses 200 may operate as the client apparatus 200A for the general user or operate as the client apparatus 200B for the administrator on the basis of authentication or the like at the time of login. Typically, a general-use computer such as a personal computer is used as the client apparatus 200, but a smart phone, a tablet device, or the like may also be used.

The monitoring camera 100 transmits a response with respect to the command from the client apparatus 200 and an image based on the image capturing by the monitoring camera 100 to the client apparatus 200.

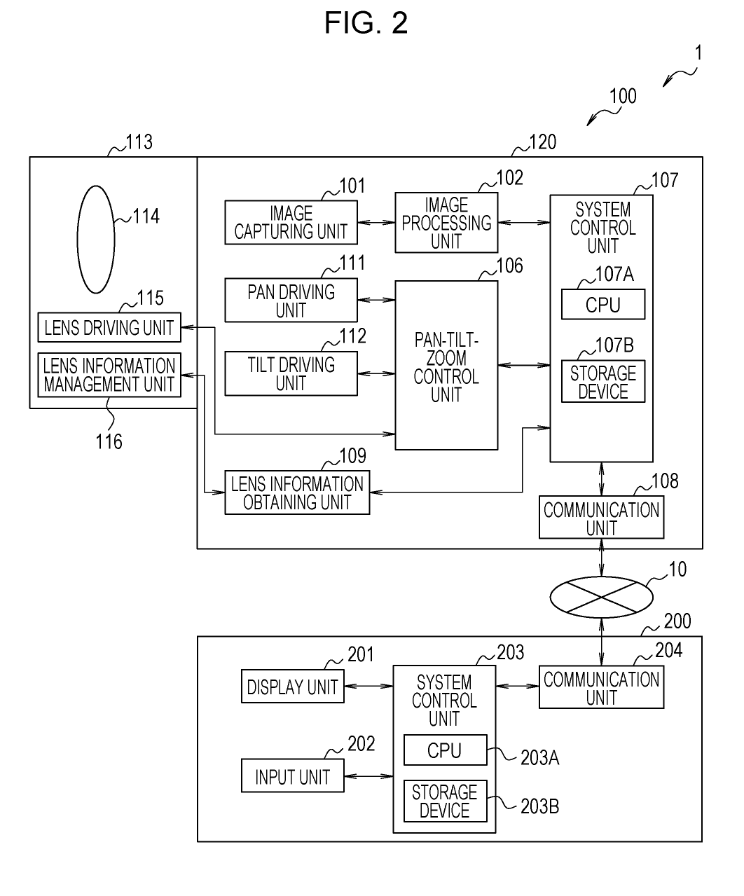

Next, a hardware configuration of the monitoring camera 100 will be described with reference to FIG. 1B and FIG. 2. FIG. 1B is an external appearance view of the monitoring camera 100. FIG. 2 is a hardware configuration diagram of the monitoring camera system 1.

The monitoring camera 100 is provided with a main body part 120 and a lens unit 113 detachably mounted to the main body part 120.

As illustrated in FIG. 2, various apparatuses of the monitoring camera 100 are mounted to the main body part 120.

The lens unit 113 is mounted to the main body part 120 of the monitoring camera 100 via a lens mount unit, and detachment and replacement from the main body part 120 can be performed. The lens unit 113 is provided with a lens 114, the lens driving unit 115, and a lens information management unit 116. A direction in which the lens 114 faces is an image capturing direction of the monitoring camera 100. Light flex that has passed through the lens 114 is imaged on an image capturing unit 101.

The lens 114 is constituted by a focus lens, a zoom lens, and the like.

The lens driving unit 115 is constituted by a driving system such as the focus lens and the zoom lens and changes a focal length of the lens 114. The lens driving unit 115 is controlled by a pan-tilt-zoom control unit 106.

The lens information management unit 116 is constituted by a circuit or the like configured to manage information of the lens 114 such as the focal length of the lens 114.

A pan driving unit 111 is constituted by a mechanical driving system and a motor of a driving source which perform a pan operation. The pan driving unit 111 is configured to perform driving so as to change the image capturing direction of the monitoring camera 100 in a pan direction. The pan driving unit 111 is controlled by the pan-tilt-zoom control unit 106.

A tilt driving unit 112 is constituted by a mechanical driving system and a motor of a driving source which perform a tilt operation. The pan driving unit 111 is configured to perform driving so as to change the image capturing direction of the monitoring camera 100 in a tilt direction. The tilt driving unit 112 is controlled by the pan-tilt-zoom control unit 106.

The image capturing unit 101 is constituted by a photoelectric conversion element such as a CCD sensor or a CMOS sensor that outputs an electric signal and configured to photoelectrically convert an object image formed by the lens unit 113 to generate the electric signal.

An image processing unit 102 performs image capturing, predetermined image processing on the photoelectrically converted signal, and encoding processing in the image capturing unit 101 to generate image data. The image processing unit 102 also uses mask area information and pan-tilt-zoom movement information transmitted from a system control unit 107 and generates a mask image to be overlapped with the image data.

The pan-tilt-zoom control unit 106 is a circuit configured to perform control of the pan driving unit 111, the tilt driving unit 112, and the lens driving unit 115 on the basis of instructions transmitted from the system control unit 107.

A communication unit 108 is a communication interface configured to perform a communication with the client apparatus 200. For example, the communication unit 108 distributes the generated image data to the client apparatus 200. In addition, the communication unit 108 receives the mask setting command and the camera control command transmitted from the client apparatus 200 and transmits the commands to the system control unit 107. The communication unit 108 also transmits the response with respect to the command transmitted by the client apparatus 200 to the client apparatus 200.

The system control unit 107 controls the entirety of the monitoring camera 100 and performs the following processing, for example. That is, the system control unit 107 analyzes the camera control command transmitted from the communication unit 108 and performs processing in accordance with the command. In addition, the system control unit 107 analyzes the mask setting command transmitted from the communication unit 108 and transmits the information on the mask area to the image processing unit 102. The system control unit 107 also receives a notification of the pan-tilt-zoom movement information from the pan-tilt-zoom control unit 106 to be transmitted to the image processing unit 102. The system control unit 107 also obtains lens insertion/removal information and focal length information from a lens information obtaining unit 109 to update the information on the mask area when necessary. Moreover, the system control unit 107 performs an instruction for an image quality adjustment with respect to the image processing unit 102. Furthermore, the system control unit 107 performs an instruction of the pan-tilt-zoom operation with respect to the pan-tilt-zoom control unit 106.

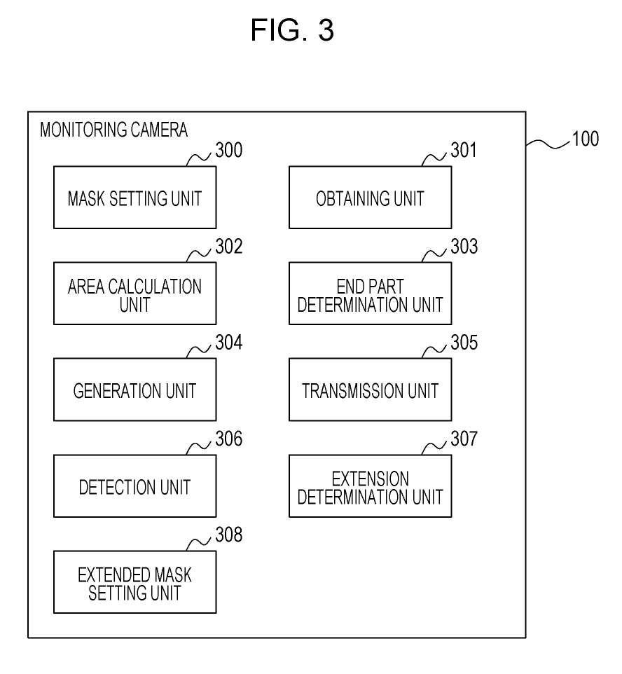

The system control unit 107 is constituted by a CPU 107A and a storage device 107B such as a RAM, a ROM, or an HDD. When the CPU 107A executes processing on the basis of a program stored in the storage device 107B or the like, a function of the monitoring camera 100 illustrated in FIG. 3 and processing of a flow chart which will be described below are realized. The storage device 107B stores the program, data used when the processing executed by the CPU 107A on the basis of the program, or the like. It should be noted that the system control unit 107 may execute the function performed by the image processing unit 102 or the pan-tilt-zoom control unit 106.

The lens information obtaining unit 109 obtains the information of the lens 114 from the lens information management unit 116 via the mount unit. The lens information obtaining unit 109 also obtains information on whether or not the lens unit 113 is attached to the main body part 120 or the like.

Next, a hardware configuration of the client apparatus 200 will be described with reference to FIG. 2.

A liquid crystal display device or the like is used as a display unit 201. The display unit 201 displays the image received from the monitoring camera 100 and a graphic user interface (hereinafter, which will be referred to as a GUI) for performing camera control.

A key board, a pointing device such as a mouse, or the like is used as an input unit 202, and the user of the client apparatus 200 operates the GUI via the input unit 202.

A system control unit 203 controls the entirety of the client apparatus 200 and performs the following processing, for example. That is, the system control unit 203 generates the mask setting command and the camera control command in accordance with GUI operations by the user to be transmitted to the monitoring camera 100 via a communication unit 204. The system control unit 203 also performs control for displaying the image data received from the monitoring camera 100 via the communication unit 204 on the display unit 201.

The system control unit 203 is constituted by a CPU 203A and a storage device 203B such as a RAM, a ROM, or an HDD. When the CPU 203A performs processing on the basis of a program stored in the storage device 203B or the like, the various functions of the client apparatus 200 are realized. The storage device 203B stores the program, data used when the CPU 203A performs the processing on the basis of the program, and the like.

The communication unit 204 is an interface configured to perform a communication with the monitoring camera 100.

Next, the function the monitoring camera 100 will be described with reference to FIG. 3. FIG. 3 is a functional block diagram of the monitoring camera 100.

A mask setting unit 300 receives the mask setting command including a mask setting value from the client apparatus 200 and saves the mask setting value to set the mask area.

An obtaining unit 301 obtains the horizontal viewing angle, the vertical viewing angle, and the focal length of the lens 114 from the lens information management unit 116 via the lens information obtaining unit 109 and the mount unit. The obtaining unit 301 also obtains a pan angle and a tilt angle from the pan-tilt-zoom control unit 106.

An area calculation unit 302 calculates various areas which will be described below on the basis of the information obtained from the obtaining unit 301 or the like.

An end part determination unit 303 determines whether or not an end part of the mask area that reaches an end part of an image capturing executable area of the monitoring camera 100 exists.

A generation unit 304 overlaps the mask image with a captured image corresponding to the image data based on the output signal of the image capturing unit 101 to generate a restricted image.

A transmission unit 305 transmits the restricted image to the client apparatus 200.

A detection unit 306 detects the replacement of the lens unit 113 or a change in the focal length of the lens 114 by monitoring a state of the mount unit or checking information from the lens information management unit 116.

An extension determination unit 307 determines whether or not the image capturing area is extended. That is, it is determined whether or not the image capturing can be executed in a still wider range in the real space. In other words, it is determined whether or not the viewing angle is widened.

An extended mask setting unit 308 sets an extended mask area and extends the extended mask area when the lens is replaced with the wide-angle lens 114. At this time, in a case where a setting is made such that the mask image that is set before the replacement of the lens 114 restricts browsing of a first area in the real space, the mask area is extended in the following manner. That is, a size of the mask image with respect to the real space is extended so as to restrict browsing of a second area which is wider than the first area in the real space. At this time, the size of the mask image with respect to the captured image may be reduced in some cases depending on a magnification of the lens.

It should be noted that details of the respective functions described herein will be described together with explanations on the flow charts and the like below.

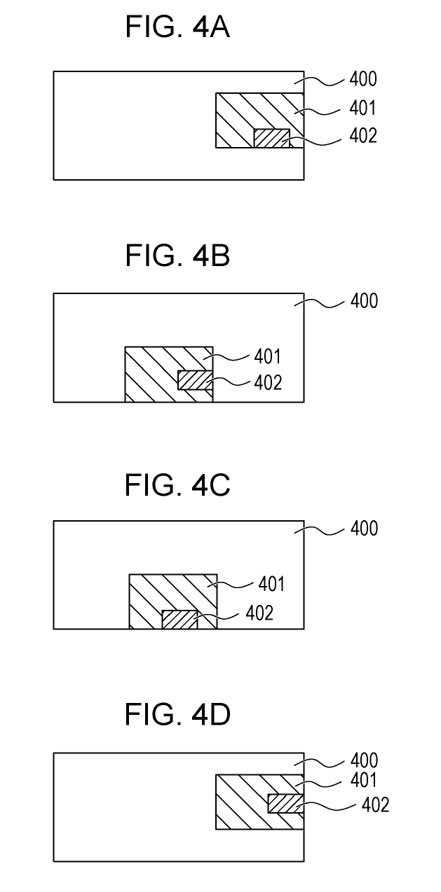

Next, the various areas used according to the present embodiment will be described with reference to FIG. 4A. FIG. 4A is a first conceptual diagram for describing the various areas.

Areas used according to the present embodiment include an image capturing executable area 400, a video area 401, and a mask area 402.

The image capturing executable area 400 is an example of the captured area and is an entire area where the image capturing unit 101 of the monitoring camera 100 can execute the image capturing. That is, the image capturing executable area 400 is an entire area where the image capturing unit 101 can perform the image capturing while the monitoring camera 100 is driven to one driving end to the other driving end of the panning and one driving end to the other driving end of the tilting in a state in which the focal length of the lens 114 is the shortest.

When the focal length of the lens 114 and the pan angle and the tilt angle of the monitoring camera 100 are at arbitrary positions, the video area 401 is an area where the image capturing unit 101 can perform the image capturing in this state. Therefore, as illustrated in FIG. 4A, the video area 401 is smaller than the image capturing executable area 400. The mask area 402 is an area where browsing of the captured image is restricted.

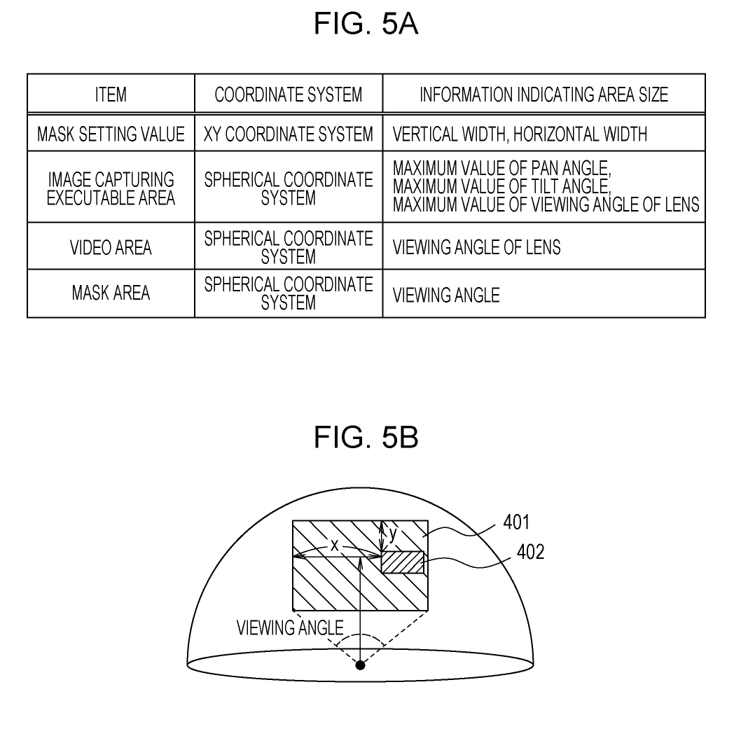

Next, the respective areas described with reference to FIGS. 4A to 4D and how the mask setting is represented will be described with reference to FIGS. 5A and 5B. FIG. 5A is a list of the respective areas and the representation for the mask setting. FIG. 5B is a conceptual diagram of spherical coordinates.

The mask setting is a setting for specifying an area set a target of the mask when the client apparatus 200 performs the setting of the mask, and the area set the target of the mask is specified by a mask setting value. In the mask setting value, an XY coordinate system where the video area 401 is set as an XY plane is used.

For the mask setting value, a reference point of the mask represented by the XY coordinate system and a vertical width and a horizontal width are used as information representing the area size of the mask. The vertical width and the horizontal width are represented by numbers of pixels, for example.

The image capturing executable area 400 is represented by a spherical coordinate system. The spherical coordinate system according to the present embodiment is a spherical coordinate system where the angle of the pan direction and the angle of the tilt direction are represented by coordinates. The image capturing executable area can be represented by the maximum value of the pan angle, the maximum value of the tilt angle, and the maximum value of the horizontal viewing angle and the maximum value of the vertical viewing angle of the lens 114. The pan angle is an angle of the pan driving unit 111 when one of the driving ends of the pan driving unit 111 is set as 0°. The tilt angle is an angle of the tilt driving unit 112 when one of the driving ends of the tilt driving unit 112 is set as 0°. The viewing angle of the lens 114 can be calculated from the focal length of the lens 114. The area size of the image capturing executable area 400 is set from a driving limit value of the pan driving unit 111, a driving limit value of the tilt driving unit 112, and a driving limit value of the lens driving unit 115.

The video area 401 is represented by the spherical coordinate system similar to that of the image capturing executable area 400. For example, the pan angle and the tilt angle are used as a reference point representing the video area 401. The area size of the video area 401 is set from the horizontal viewing angle and the vertical viewing angle of the lens 114.

The mask area 402 is represented by the spherical coordinate system similar to that of the image capturing executable area 400. A range of the mask area 402 is represented by the horizontal viewing angle and the vertical viewing angle. A reference point in the spherical coordinate system of the mask area 402 can be set from the reference point included in the mask setting value, the pan angle and the tilt angle of the video area 401 set in the XY coordinate system of the mask setting value, and the viewing angle of the lens 114. The area size of the mask area 402 can be represented by the horizontal viewing angle and the vertical viewing angle. The horizontal viewing angle and the vertical viewing angle can be set from the area size included in the mask setting value, the pan angle and the tilt angle of the video area 401 set in the XY coordinate system of the mask setting value, and the viewing angle of the lens 114. Therefore, the mask area 402 can be determined from the mask setting value and the video area 401. It should be noted that the extended mask area is also represented by a similar method to that of the mask area 402.

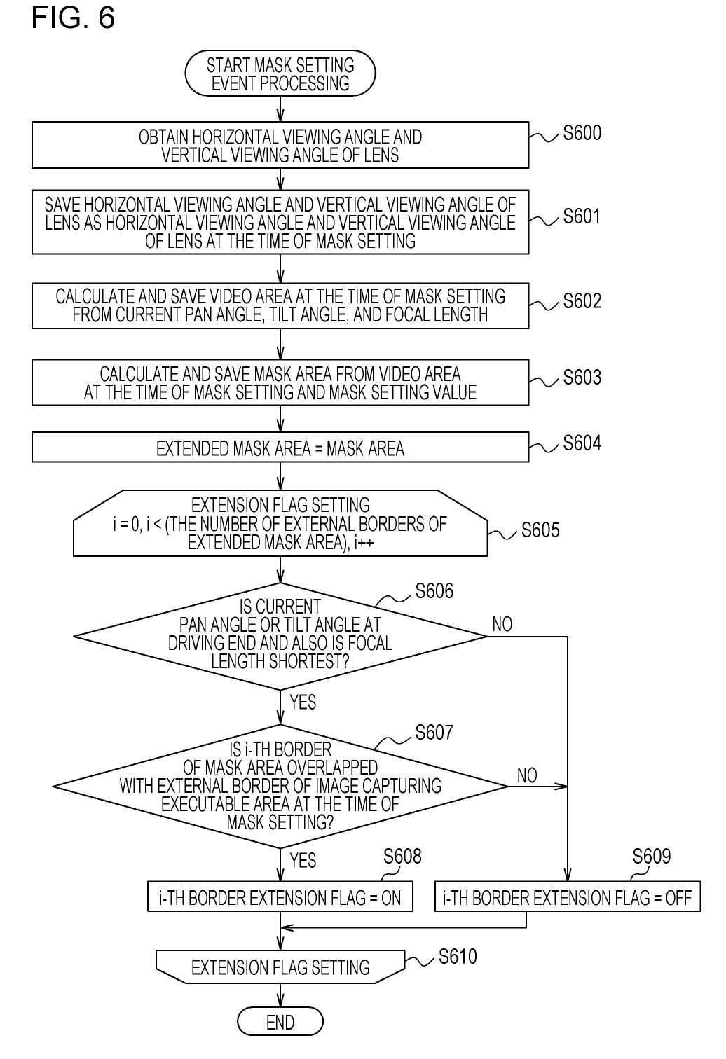

Next, mask setting event processing will be described with reference to FIG. 6. FIG. 6 is a flow chart of the mask setting event processing. The mask setting event processing is processing of the monitoring camera 100 when the mask setting unit 300 receives the mask setting command including the mask setting value from the client apparatus 200 and saves the mask setting value in the storage device 107B.

In step S600, the obtaining unit 301 obtains the horizontal viewing angle and the vertical viewing angle of the lens 114 in the lens unit 113 currently mounted to the main body part 120. At this time, the obtaining unit 301 obtains the horizontal viewing angle and the vertical viewing angle of the lens 114 when the focal length of the lens 114 is the shortest, for example.

In step S601, the obtaining unit 301 saves the horizontal viewing angle and the vertical viewing angle of the lens 114 obtained in step S600 in the storage device 107B as the horizontal viewing angle and the vertical viewing angle of the lens 114 at the time of the mask setting.

In step S602, the obtaining unit 301 obtains the pan angle and the tilt angle. The obtaining unit 301 also obtains the focal length of the lens 114 in the lens unit 113 currently mounted to the main body part 120. Then, the area calculation unit 302 calculates the video area 401 from the pan angle, the tilt angle, and the focal length obtained by the obtaining unit 301 and saves the calculated video area 401 in the storage device 107B as the video area 401 at the time of the mask setting.

In step S603, the area calculation unit 302 calculates the mask area 402 from the video area 401 at the time of the mask setting calculated in step S602 and the mask setting value received by the mask setting unit 300 and saves the calculated mask area 402 in the storage device 107B. The area calculation unit 302 assigns numbers starting from 0 to respective borders of the mask area 402. Even when a plurality of the mask areas 402 exist, the area calculation unit 302 sets the numbers of the respective external borders of the mask areas 402 so as not to have a duplication. The external border of the mask area 402 to which a number n is assigned is referred to as an n-th border.

In step S604, the extended mask setting unit 308 sets the extended mask area so as to represent the same area as the mask area calculated in step S603. The border of the extended mask area overlapped with the n-th border of the mask area will be also referred to as the n-th border of the extended mask area.

In step S605, the end part determination unit 303 performs start processing of extension flag setting processing corresponding to the loop processing. That is, in step S605 for the first time, the end part determination unit 303 assigns 0 to a variable i. In step S605 for the second and subsequent times, the end part determination unit 303 increments the variable i. After 0 is assigned to the variable i or the variable i is incremented, the end part determination unit 303 determines whether or not the variable i is lower than the number of external borders of the extended mask area. When the variable i is lower than the number of external borders of the extended mask area, the end part determination unit 303 proceeds the processing to step S606. When the variable i is higher than or equal to the number of external borders of the extended mask area, the end part determination unit 303 ends the extension flag setting processing to end the mask setting event processing of FIG. 6.

In step S606, the end part determination unit 303 determines whether or not the following first condition and the second condition are satisfied. The first condition is that the pan angle obtained in step S602 is the driving end of the pan driving unit 111 or the tilt angle obtained in step S602 is the driving end of the tilt driving unit 112. The second condition is that the focal length obtained in step S602 has the minimum value that can be realized by the lens driving unit 115. When the first condition and the second condition are satisfied, the end part determination unit 303 proceeds the processing to step S607. When the first condition and the second condition are not satisfied, the end part determination unit 303 proceeds the processing to step S609.

In step S607, the end part determination unit 303 determines whether or not the i-th border of the mask area 402 is overlapped with any one of the external borders of the image capturing executable area 400 at the time of the mask setting. When the i-th border is overlapped with any one of the external borders, the end part determination unit 303 proceeds the processing to step S608. When the i-th border is not overlapped with any one of the external borders, the end part determination unit 303 proceeds the processing to step S609.

In step S608, the end part determination unit 303 sets the i-th border extension flag as ON.

In step S609, the end part determination unit 303 sets the i-th border extension flag as OFF.

Here, an example of the processing from step S606 to step S609 will be described with reference to FIGS. 4A to 4D. In each example of FIGS. 4A to 4D, the lens driving unit 115 is at the driving end, and the focal length of the lens 114 is the shortest.

In the case of FIGS. 4A and 4D, since the right border of the video area 401 is overlapped with the right border of the image capturing executable area 400, the pan angle is set at the driving end of the pan driving unit 111. Therefore, the processing proceeds from step S606 to step S607.

In the case of FIGS. 4B and 4C, since the bottom border of the video area 401 is overlapped with the bottom border of the image capturing executable area 400, the tilt angle is set at the driving end of the tilt driving unit 112. Therefore, the processing proceeds from step S606 to step S607.

In the case of FIG. 4A, the bottom border of the mask area 402 is overlapped with the bottom border of the video area 401 but is not overlapped with any of the external borders of the image capturing executable area 400. Therefore, at the time of the processing on the bottom border of the mask area 402, the processing proceeds from step S607 to step S609, and an extension area flag corresponding to the bottom border is set as OFF.

Similarly, in the case of FIG. 4B, the right border of the mask area 402 is overlapped with the right border of the video area 401 but is not overlapped with any of the external borders of the image capturing executable area 400. Therefore, at the time of the processing on the right border of the mask area 402, the processing proceeds from step S607 to step S609, and the extension area flag corresponding to the right border is set as OFF.

On the other hand, in the case of FIG. 4C, the bottom border of the mask area 402 is overlapped with the bottom border of the image capturing executable area 400. Therefore, at the time of the processing on the bottom border of the mask area 402, the processing proceeds from step S607 to step S608, and the extension area flag corresponding to the bottom border of the mask area 402 is set as ON.

Similarly, in the case of FIG. 4D, the right border of the mask area 402 is overlapped with the right border of the image capturing executable area 400. Therefore, at the time of the processing on the right border of the mask area 402, the processing proceeds from step S607 to step S608, and the extension area flag corresponding to the right border of the mask area 402 is set as ON.

In step S610, the end part determination unit 303 performs loop end processing of the extension flag setting processing corresponding to the loop processing. That is, the end part determination unit 303 returns the processing to step S605.

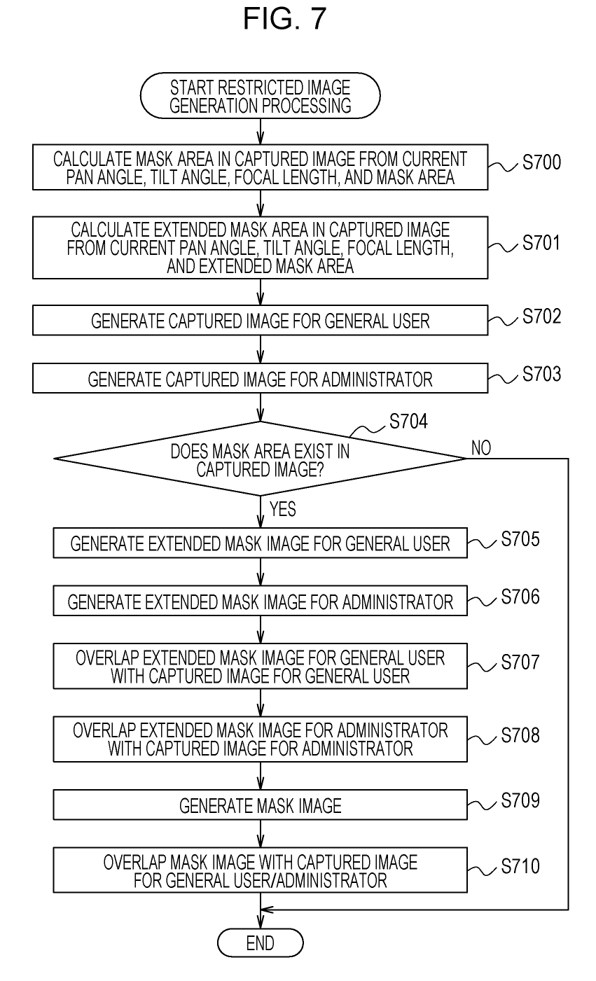

Next, with reference to FIG. 7, restricted image generation processing will be described. FIG. 7 is a flow chart of the restricted image generation processing.

In step S700, the obtaining unit 301 obtains the horizontal viewing angle, the vertical viewing angle, and the focal length of the lens 114 in the lens unit 113 currently mounted to the main body part 120. The area calculation unit 302 calculates the mask area in the captured image obtained by the image capturing unit 101 from the obtained horizontal viewing angle, the vertical viewing angle, and the focal length and the mask area 402.

In step S701, the area calculation unit 302 calculates the extended mask area in the captured image obtained by the image capturing unit 101 from the obtained horizontal viewing angle, the vertical viewing angle, and the focal length and the extended mask area.

In step S702, the generation unit 304 generates the captured image for the general user. The captured image for the general user is generated by the image processing unit 102 on the basis of the image capturing by the image capturing unit 101.

In step S703, the generation unit 304 generates the captured image for the administrator. The captured image for the administrator is generated by the image processing unit 102 on the basis of the image capturing by the image capturing unit 101. The captured image for the administrator may be the same as the captured image for the general user or may be an image on which different image processing from that of the captured image for the general user is performed or the like.

In step S704, the generation unit 304 determines whether or not the mask area exists in the captured image. When the mask area exists in the captured image, the generation unit 304 proceeds the processing to step S705. When the mask area does not exist in the captured image, the generation unit 304 ends the restricted image generation processing of FIG. 7. Any one of the captured image for the general user and the captured image for the administrator may be used as the captured image used in this determination.

In step S705, the generation unit 304 generates the extended mask image for the general user. The extended mask image for the general user is an opaque image.

In step S706, the generation unit 304 generates the extended mask image for the administrator. The extended mask image for the administrator has a high transmittance and is a transmissive image.

In step S707, the generation unit 304 overlaps the extended mask image for the general user generated in step S705 with the extended mask area calculated in step S701 in the captured image for the general user generated in step S702.

In step S708, the generation unit 304 overlaps the extended mask image for the administrator generated in step S706 with the extended mask area calculated in step S701 in the captured image for the administrator generated in step S703.

In step S709, the generation unit 304 generates the mask image. The mask image is an opaque image. The generation unit 304 sets a color of the mask image to be different from a color of the extended mask image for the general user generated in step S705 and a color of the extended mask image for the administrator generated in step S706.

In step S710, the generation unit 304 overlaps the mask image generated in step S709 with the mask area calculated in step S700 in the captured image for the general user with which the extended mask image is overlapped in step S707. In addition, the generation unit 304 overlaps the mask image generated in step S709 with the mask area calculated in step S700 in the captured image for the administrator with which the extended mask image is overlapped in step S708.

The processing of overlapping the extended mask image or the mask image with the captured image is a process example of applying the mask to the captured image.

The image obtained by overlapping at least one of the extended mask image for the general user and the mask image with the captured image for the general user generated in step S702 is the restricted image for the general user. The image obtained by overlapping at least one of the extended mask image for the administrator and the mask image with the captured image for the administrator generated in step S703 is the restricted image for the administrator.

The transmission unit 305 transmits the restricted image for the general user generated by the restricted image generation processing of FIG. 7 to the client apparatus 200A for the general user. The transmission unit 305 also transmits the restricted image for the administrator generated by the restricted image generation processing of FIG. 7 to the client apparatus 200B for the administrator. When the captured image is not overlapped with any of the extended mask image and the mask image, the transmission unit 305 transmits the captured image for the general user to the client apparatus 200A for the general user and transmits the captured image for the administrator to the client apparatus 200B for the administrator.

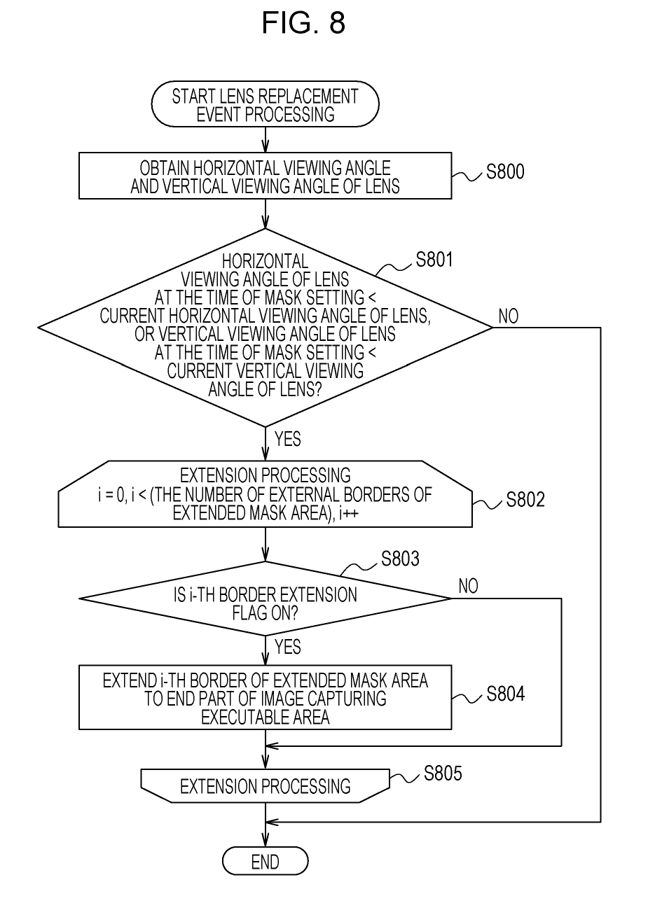

Next, lens replacement event processing will be described with reference to FIG. 8. FIG. 8 is a flow chart of the lens replacement event processing. The lens replacement event processing is processing performed when the detection unit 306 detects the replacement of the lens unit 113 mounted to the main body part 120.

In step S800, the obtaining unit 301 obtains the horizontal viewing angle and the vertical viewing angle of the lens 114 in the lens unit 113 currently mounted to the main body part 120. At this time, the obtaining unit 301 obtains the horizontal viewing angle and the vertical viewing angle of the lens 114 when the focal length of the lens 114 is the shortest, for example.

In step S801, the extension determination unit 307 determines whether or not the image capturing executable area 400 is extended. That is, the extension determination unit 307 compares the current horizontal viewing angle of the lens 114 obtained in step S800 with the horizontal viewing angle of the lens 114 at the time of the mask setting. In addition, the extension determination unit 307 compares the current vertical viewing angle of the lens 114 obtained in step S800 with the vertical viewing angle of the lens 114 at the time of the mask setting. When the current horizontal viewing angle of the lens 114 is wider than the horizontal viewing angle of the lens 114 at the time of the mask setting or the current vertical viewing angle of the lens 114 is wider than the vertical viewing angle of the lens 114 at the time of the mask setting, the extension determination unit 307 determines that the image capturing executable area 400 is extended. When it is determined that the image capturing executable area 400 is extended, the extension determination unit 307 proceeds the processing to step S802. When it is determined that the image capturing executable area 400 is not extended, the extension determination unit 307 ends the lens replacement event processing of FIG. 8.

In step S802, the extension determination unit 307 performs start processing of extension processing corresponding to loop processing. That is, in step S802 for the first time, the extension determination unit 307 assigns 0 to the variable i In step S802 for the second and subsequent times, the extension determination unit 307 increments the variable i. After 0 is assigned to the variable i or the variable i is incremented, the extension determination unit 307 determines whether or not the variable i is lower than the number of external borders of the extended mask area. When the variable i is lower than the number of external borders of the extended mask area, the extension determination unit 307 proceeds the processing to step S803. When the variable i is higher than or equal to the number of external borders of the extended mask area, the extension determination unit 307 ends the extension flag setting processing to end the lens replacement event processing of FIG. 8.

In step S803, the extension determination unit 307 determines whether or not the i-th border extension flag is ON. When the i-th border extension flag is ON, the extension determination unit 307 proceeds the processing to step S804. When the i-th border extension flag is OFF, the extension determination unit 307 proceeds the processing to step S805.

In step S804, the extended mask setting unit 308 extends the i-th border of the extended mask area to the end part of the image capturing executable area 400 after the extension corresponding to the i-th border. The end part of the image capturing executable area 400 corresponding to the i-th border of the extended mask area is the end part of the image capturing executable area 400 on the same side as the i-th border of the extended mask area as viewed from a central part of the extended mask area. For example, when the i-th border of the extended mask area is the right border, the end part of the image capturing executable area 400 corresponding to the right border of the extended mask area is set at the right border of the image capturing executable area 400.

In step S805, the extension determination unit 307 performs loop end processing of the extension processing corresponding to the loop processing. That is, the extension determination unit 307 returns the processing to step S802.

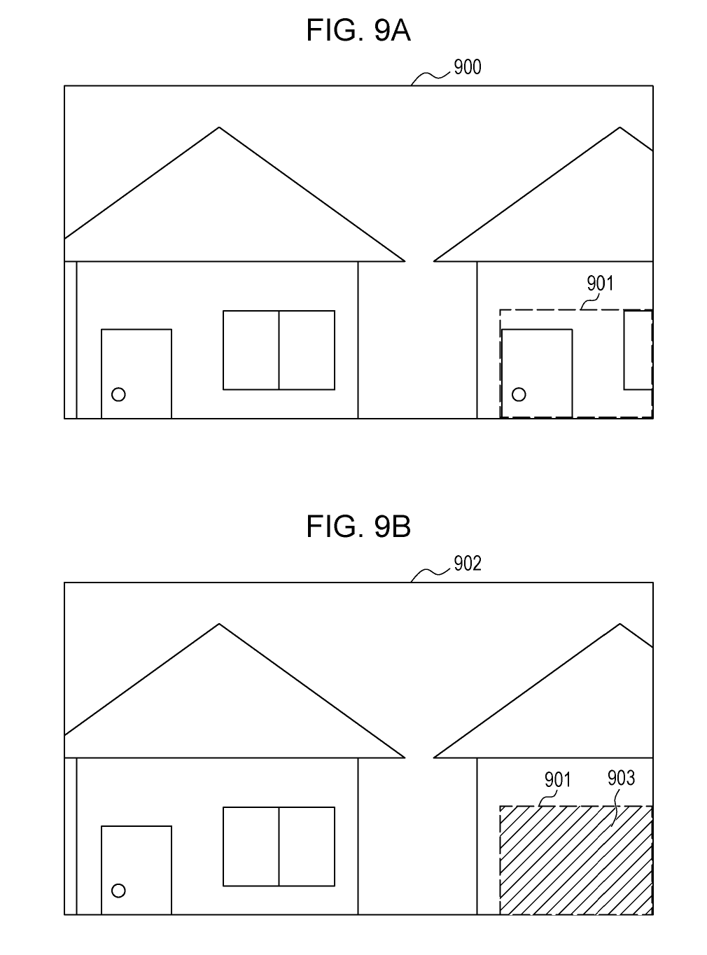

Next, examples of the captured image and the restricted image will be described with reference to FIGS. 9A to 9D.

First, the example of the captured image will be described with reference to FIG. 9A. FIG. 9A illustrates the example of the captured image. A captured image 900 of FIG. 9A is a captured image in a state in which the pan driving unit 111, the tilt driving unit 112 is at the driving end, the pan driving unit 111 is not moved to the right any further, and the tilt driving unit 112 is not moved to the bottom any further. Therefore, the monitoring camera 100 does not perform the image capturing to the right and the bottom any further. In addition, the lens driving unit 115 is at the driving end, and the monitoring camera 100 does not capture the image at the wider viewing angle any further. The captured image 900 is a captured image immediately before the mask setting of the mask area 901 is received from the client apparatus 200, and the mask is not applied to the captured image 900.

Next, an example of the restricted image for the general user will be described with reference to FIG. 9B. FIG. 9B is an explanatory diagram for describing the example of the restricted image for the general user. The restricted image 902 of FIG. 9B the restricted image for the general user 902 generated by the generation unit 304 when the mask setting of the mask area 901 is received from the client apparatus 200 after the monitoring camera 100 obtains the captured image 900 of FIG. 9A. As illustrated in FIG. 9B, the restricted image 902 is an image obtained by overlapping the mask image 903 for the general user of an arbitrary color with the set mask area 901.

As illustrated in FIG. 9B, the right border and the bottom border of the mask area 901 are respectively overlapped with the right border and the bottom border of the captured image 900. The monitoring camera 100 does not perform the image capturing to the right and the bottom any further or capture the image at the wider viewing angle any further. Thus, the right border and the bottom border of the captured image 900 become at least parts of the right border and the bottom border of the image capturing executable area 400. Therefore, since the right border and the bottom border of the mask area 901 are overlapped with the right border and the bottom border of the image capturing executable area 400, in step S608 of FIG. 6, extension flags with regard to the right border and the bottom border of the mask area 901 are set as ON. For example, when the right border of the mask area 901 is a first border and the bottom border of the mask area 901 is a second border, a first border extension flag and a second border extension flag are set as ON.

Next, a state in which the image capturing executable area 400 is extended will be described with reference to FIG. 9C. FIG. 9C illustrates an example of an image immediately before the area where the browsing is restricted in the real space is extended when the image capturing executable area 400 is extended. An image 904 of FIG. 9C corresponds to an example of an image immediately before the mask area is relatively extended with respect to the real space immediately after the lens unit 113 is replaced after the monitoring camera 100 generates the restricted image 902 of FIG. 9B. With the replacement of the lens unit 113, it is assumed that the minimum value of the focal length of the lens 114 based on the driving of the lens driving unit 115 becomes lower as compared with the state before the replacement.

As described above, the extension flags with regard to the right border and the bottom border of the mask area are set as ON. Therefore, in step S804 of FIG. 8, the right border and the bottom border of the extended mask area 906 that is the same area as the mask area 901 at the beginning are extended to the right border and the bottom border of the image capturing executable area 400 corresponding to these borders. The extended mask area 906 is extended by a viewing angle difference 905 based on the replacement of the lens unit 113 as compared with the mask area 901.

Next, the restricted image for the general user after the image capturing executable area 400 is extended will be described with reference to FIG. 9D. FIG. 9D illustrates an example of the restricted image for the general user 909 after the image capturing executable area 400 is extended. As illustrated in FIG. 9D, an area 907 that is not overlapped with the mask area 901 in the extended mask area 906 is overlapped with the extended mask image for the general user 908 having a color different from the mask image 903. The area 907 is the extended mask area before the extension by the extended mask setting unit 308, that is, a difference area between the mask area 901 and the extended mask area 906 after the extension by the extended mask setting unit 308.

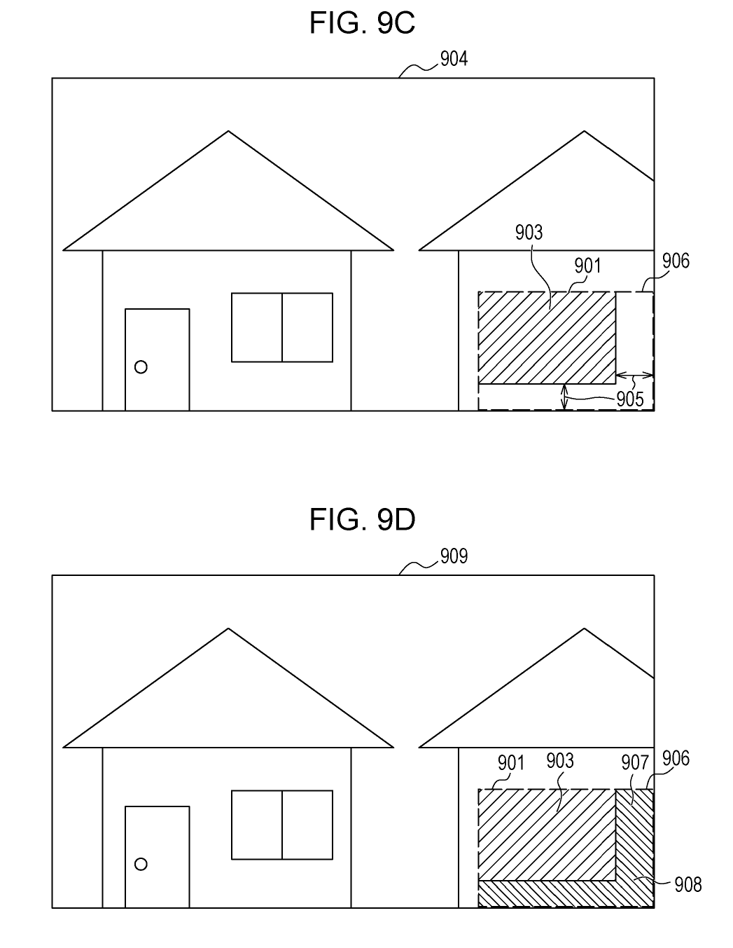

Next, a difference between the restricted image for the general user 909 and the restricted image for the administrator 1000 will be described with reference to FIG. 10A and FIG. 10B. FIG. 10A illustrates an example of the restricted image for the general user 909. FIG. 10B illustrates an example of the restricted image for the administrator 1000. FIG. 10A is the same illustration as the restricted image for the general user 909 of FIG. 9D.

As illustrated in FIG. 10A, the mask area 901 is overlapped with the mask image 903 in the restricted image for the general user 909, and the general user does not perform the browsing of the mask area 901 part. The area 907 that is not overlapped with the mask area 901 in the extended mask area 906 is overlapped with the extended mask image for the general user 908, and the browsing of the video of the area 907 part is not performed. The mask area 901 and the area 907 are set to have different colors.

As illustrated in FIG. 10B, the mask area 901 is overlapped with the mask image 903 in the restricted image for the administrator 1000, and the administrator does not perform the browsing of the video of the mask area 901 part similarly as in the general user. However, the extended mask image for the administrator 1001 having a high transmittance is used as the mask image of the area 907. Therefore, the administrator can perform the browsing of the area 907 unlike the general user.

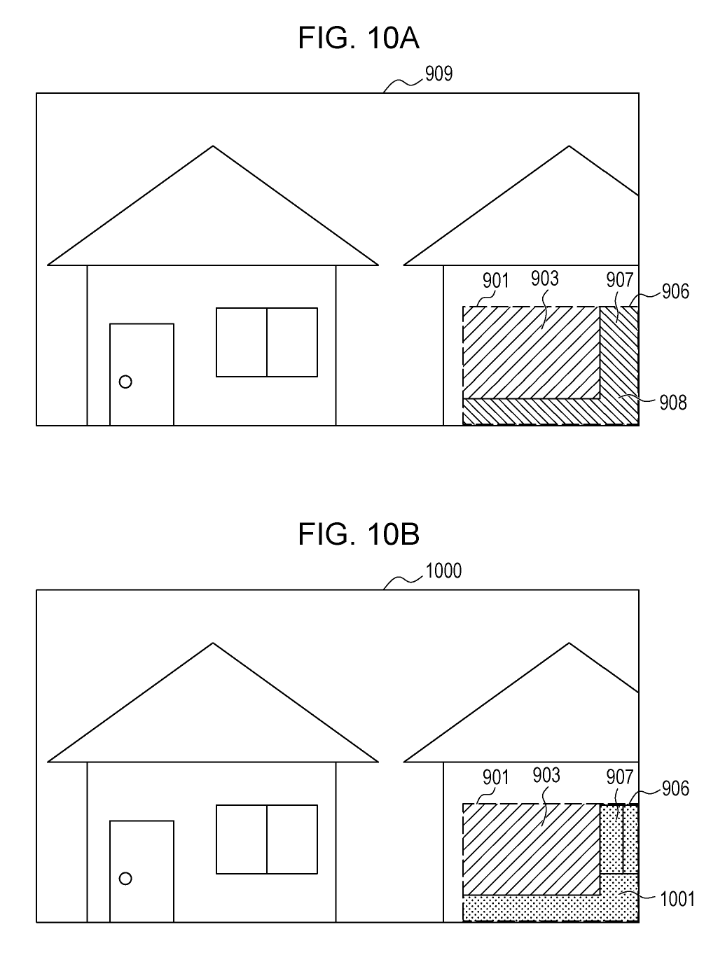

Next, the mask area extension condition will be described with reference to FIG. 11. FIG. 11 illustrates examples of a first image capturing executable area 1100 and a second image capturing executable area 1101. The mask area extension condition is a condition for extending the extended mask area that is set so as to be equal to the mask area in step S604 of FIG. 6 and is a condition determined in step S607 of FIG. 6.

The first image capturing executable area 1100 is an image capturing executable area at the time of the mask setting. The second image capturing executable area 1101 is an image capturing executable area after the lens unit 113 is replaced after the mask setting. It is assumed that the minimum value of the focal length of the lens 114 based on the driving of the lens driving unit 115 becomes lower than the state before the replacement by the replacement of the lens unit 113. A first mask area 1102, a second mask area 1103, and a third mask area 1104 are mask areas that are set before the replacement of the lens unit 113.

The external border of the first mask area 1102 is not overlapped with the external border of the first image capturing executable area 1100. Thus, the external border of the first mask area 1102 does not satisfy the mask area extension condition. Therefore, even when the lens unit 113 is replaced with a lens in which the minimum value of the focal length is low, in step S804 of FIG. 8, the extended mask area corresponding to the first mask area 1102 is not extended.

The bottom border of the second mask area 1103 is overlapped with the bottom border of the first image capturing executable area 1100. Thus, the bottom border of the second mask area 1103 satisfies the mask area extension condition. Therefore, when the lens unit 113 is replaced with the lens in which the minimum value of the focal length is low, the extended mask area corresponding to the second mask area 1103 in step S804 of FIG. 8 is extended to the bottom border of the second image capturing executable area 1101. In this manner, the area where the browsing is restricted is extended by an area 1105 of FIG. 11. Then, the area 1105 is additionally masked.

The right border and the bottom border of the third mask area 1104 are respectively overlapped with the right border and the bottom border of the first image capturing executable area 1100. Thus, the right border and the bottom border of the third mask area 1104 satisfy the mask area extension condition. Therefore, when the lens unit 113 is replaced with a lens in which the minimum value of the focal length is low, in step S804 of FIG. 8, the extended mask area corresponding to the third mask area 1104 is extended to the right border and the bottom border of the second image capturing executable area 1101. In this manner, the area where the browsing is restricted is extended by an area 1106 of FIG. 11. Then, the area 1106 is additionally masked.

As described above, if the mask area 402 is set and also the image capturing executable area 400 is extended, the extended mask setting unit 308 relatively extends the extended mask area with respect to the real space. Therefore, even in a case where the image capturing executable area 400 is extended, the monitoring camera 100 can appropriately set the area where the browsing is restricted, and it is possible to reduce the risk of browsing the area where the browsing should be restricted. In addition, it is possible to save the work for the administrator or the like to set the area where the browsing is restricted again.

When the lens unit 113 is replaced and the viewing angle of the lens 114 is increased, the extension determination unit 307 determines that the image capturing executable area 400 is extended. Therefore, the administrator or the like does not need to notify the monitoring camera 100 that the viewing angle of the lens 114 is increased.

The end part determination unit 303 determines whether or not the external border of the mask area 402 overlapped with the external border of the image capturing executable area 400 exists and sets the extension flag corresponding to the external border of the mask area 402. If the mask area 402 is set and the image capturing executable area 400 is extended, the extended mask setting unit 308 extends the extended mask area that is set so as to be equal to the mask area 402 at the beginning on the basis of the end part determination unit 303. At this time, the extended mask setting unit 308 extends the external border of the extended mask area corresponding to the external border of the mask area 402 overlapped with the external border of the image capturing executable area 400 before the extension to the external border of the image capturing executable area 400 after the extension corresponding to this external border. Thus, even in a case where the image capturing executable area 400 is extended, the area where the browsing is restricted is not too wide, and it is possible to appropriately set the area where the browsing is restricted.

The generation unit 304 generates the restricted image for the general user 909. As described with reference to FIG. 9D, the area 907 that is not overlapped with the mask area 901 in the extended mask area 906 has a color different from the mask image 903 in the restricted image for the general user 909. Therefore, the general user can recognize the area where the browsing is automatically restricted by the extension of the image capturing executable area 400.

The generation unit 304 generates the restricted image for the administrator 1000. As described with reference to FIG. 10B, the restricted image for the administrator 1000 can browse the area 907 that is not overlapped with the mask area 901 in the extended mask area 906. Therefore, the administrator can decide whether or not the area where the browsing is automatically restricted by the extension of the image capturing executable area 400 includes an item where the browsing should be allowed, for example.

### Second Embodiment

According to the first embodiment, when the external border of the mask area is overlapped with the external border of the image capturing executable area at the time of the mask setting, this overlapping external border of the mask area is extended. However, when the wide-angle lens 114 is replaced, a mask may be applied to the entire extended area of the image capturing executable area. The monitoring camera system 1 that takes this aspect into account will be described below. It should be noted that descriptions of aspects similar to the above-described embodiment will be omitted.

First, functions of the monitoring camera 100 according to the present embodiment will be described. The monitoring camera 100 is further provided with an initialization unit as the function. The initialization unit initializes the setting or the like of the monitoring camera 100 on the basis of a user instruction or the like.

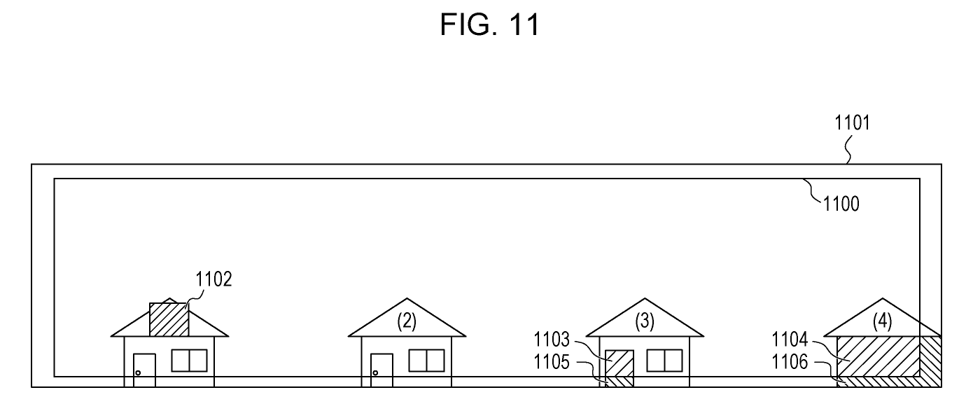

Next, with reference to FIG. 12, initialization event processing will be described. FIG. 12 is a flow chart of the initialization event processing. The initialization event processing is processing executed when the initialization unit initializes the setting or the like of the monitoring camera 100.

In step S1200, the obtaining unit 301 obtains the horizontal viewing angle and the vertical viewing angle of the lens 114 in the lens unit 113 currently mounted to the main body part 120. At this time, the obtaining unit 301 obtains the horizontal viewing angle and the vertical viewing angle of the lens 114 when the focal length of the lens 114 is the shortest, for example.

In step S1201, the obtaining unit 301 saves the horizontal viewing angle and the vertical viewing angle of the lens 114 obtained in step S1200 in the storage device 107B as the horizontal viewing angle and the vertical viewing angle of the lens 114 before the lens replacement.

In step S1202, the extended mask setting unit 308 sets the extended mask area as invalid.

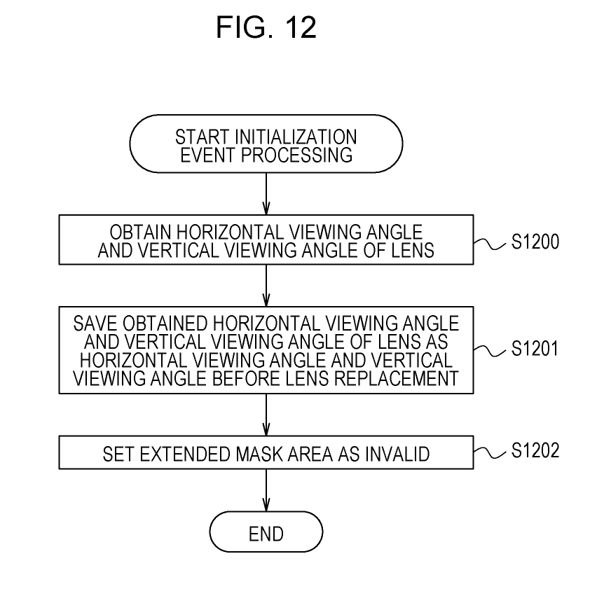

Next, the restricted image generation processing will be described with reference to FIG. 13. FIG. 13 is a flow chart of the restricted image generation processing.

Since step S700 to step S703 of FIG. 13 are similar to step S700 to step S703 of FIG. 7, descriptions thereof will be omitted.

In step S1300, the generation unit 304 determines whether or not the mask area exists in the captured image. When the mask area exists in the captured image, the generation unit 304 proceeds the processing to step S1301. When the mask area does not exist in the captured image, the generation unit 304 proceeds the processing to step S1303. Any one of the captured image for the general user and the captured image for the administrator may be used as the captured image used in this determination.

In step S1301, the generation unit 304 generates the mask image. The mask image is an opaque image.

In step S1302, the generation unit 304 overlaps the mask image generated in step S1301 with the mask area calculated in step S700 in the captured image for the general user generated in step S702. In addition, the generation unit 304 overlaps the mask image generated in step S1301 with the mask area calculated in step S700 in the captured image for the administrator generated in step S703.

In step S1303, the generation unit 304 determines whether or not the extended mask area exists in the captured image. When the extended mask area exists in the captured image, the generation unit 304 proceeds the processing to step S1304. When the extended mask area does not exist in the captured image, the generation unit 304 ends the restricted image generation processing of FIG. 13. Any one of the captured image for the general user and the captured image for the administrator may be used as the captured image used in this determination.

In step S1304, the generation unit 304 generates the extended mask image for the general user. The extended mask image for the general user is an opaque image.

In step S1305, the generation unit 304 generates the extended mask image for the administrator. The extended mask image for the administrator has a high transmittance and is a transmissive image.

In step S1306, the generation unit 304 overlaps the extended mask image for the general user generated in step S1304 with the extended mask area calculated in step S701 in the captured image for the general user. When the processing in step S1302 is performed, the captured image set as the overlap target of the extended mask image is the captured image for the general user with which the mask image is overlapped in step S1302. When the processing in step S1302 is not performed, the captured image set as the overlap target of the extended mask image is the captured image for the general user generated in step S702 of FIG. 13.

In step S1307, the generation unit 304 overlaps the extended mask image for the administrator generated in step S1305 with the extended mask area calculated in step S701 in the captured image for the administrator. When the processing in step S1302 is performed, the captured image set as the overlap target of the extended mask image is the captured image for the administrator with which the mask image is overlapped in step S1302. When the processing in step S1302 is not performed, the captured image set as the overlap target of the extended mask image is the captured image for the administrator generated in step S703 of FIG. 13.

The image obtained by overlapping at least one of the extended mask image for the general user and the mask image with the captured image for the general user generated in step S702 is the restricted image for the general user. The image obtained by overlapping at least one of the extended mask image for the administrator and the mask image with the captured image for the administrator generated in step S703 is the restricted image for the administrator.

The transmission unit 305 transmits the restricted image for the general user generated by the restricted image generation processing of FIG. 13 to the client apparatus 200A for the general user. In addition, the transmission unit 305 transmits the restricted image for the administrator generated by the restricted image generation processing of FIG. 13 to the client apparatus 200B for the administrator. When the captured image is not overlapped with any of the extended mask image and the mask image, the transmission unit 305 transmits the captured image for the general user to the client apparatus 200A for the general user and transmits the captured image for the administrator to the client apparatus 200B for the administrator.

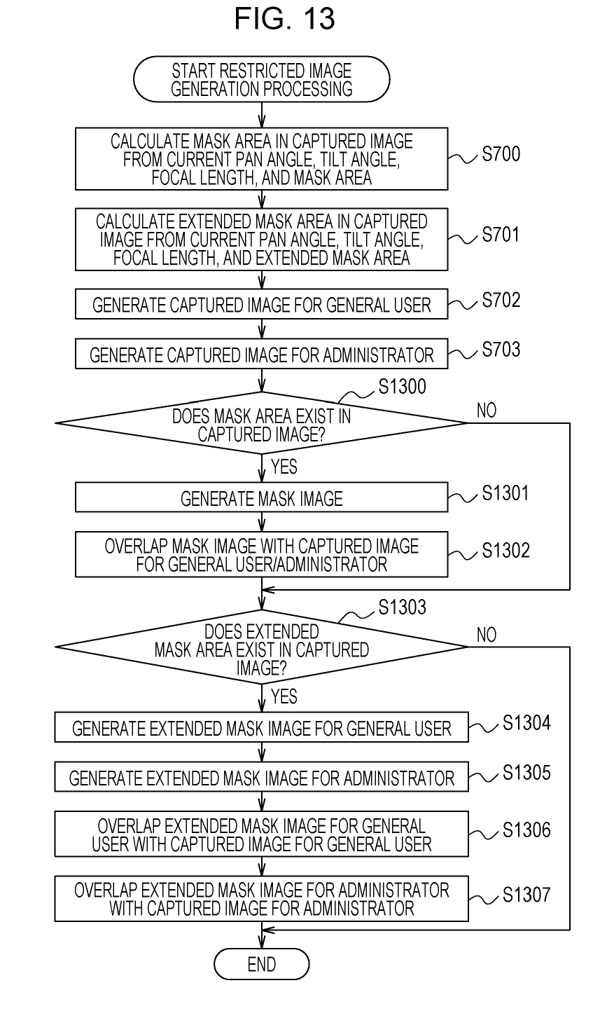

Next, the lens replacement event processing will be described with reference to FIG. 14. FIG. 14 is a flow chart of the lens replacement event processing. The lens replacement event processing is processing performed when the detection unit 306 detects the replacement of the lens unit 113 mounted to the main body part 120.

In step S1400, the obtaining unit 301 obtains the horizontal viewing angle and the vertical viewing angle of the lens 114 in the lens unit 113 currently mounted to the main body part 120. At this time, the obtaining unit 301 obtains the horizontal viewing angle and the vertical viewing angle of the lens 114 when the focal length of the lens 114 is the shortest, for example.

In step S1401, the extension determination unit 307 determines whether or not the image capturing executable area 400 is extended. That is, the extension determination unit 307 compares the current horizontal viewing angle of the lens 114 obtained in step S1400 with the horizontal viewing angle of the lens 114 before the lens replacement. In addition, the extension determination unit 307 compares the current vertical viewing angle of the lens 114 obtained in step S1400 with the vertical viewing angle of the lens 114 before the lens replacement. When the current horizontal viewing angle of the lens 114 is wider than the horizontal viewing angle of the lens 114 before the lens replacement or the current vertical viewing angle of the lens 114 is wider than the vertical viewing angle of the lens 114 before the lens replacement, the extension determination unit 307 determines that the image capturing executable area 400 is extended. When it is determined that the image capturing executable area 400 is extended, the extension determination unit 307 proceeds the processing to step S1402. When it is determined that the image capturing executable area 400 is not extended, the extension determination unit 307 proceeds the processing to step S1403.

In step S1402, the extended mask setting unit 308 sets the extended mask area as a viewing angle difference area corresponding to a difference area between the image capturing executable area before the replacement of the lens unit 113 and the image capturing executable area after the replacement of the lens unit 113.

In step S1403, the extended mask setting unit 308 sets the extended mask area as invalid.

In step S1404, the obtaining unit 301 saves the horizontal viewing angle and the vertical viewing angle of the lens 114 obtained in step S1400 in the storage device 107B as the horizontal viewing angle and the vertical viewing angle of the lens 114 before the lens replacement.

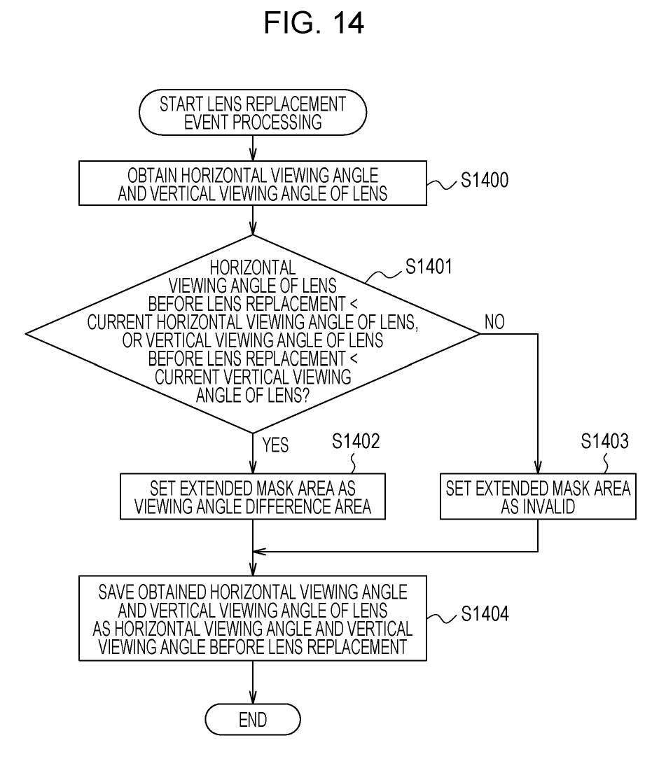

Next, a relationship between the image capturing executable area and the mask area according to the present embodiment will be described with reference to FIG. 15. FIG. 15 illustrates an example of the image capturing executable area.

A first image capturing executable area 1500 is an image capturing executable area before the replacement of the lens unit 113. A second image capturing executable area 1501 is an image capturing executable area after the replacement of the lens unit 113. It is assumed that the minimum value of the focal length of the lens 114 based on the driving of the lens driving unit 115 becomes lower than the state before the replacement by the replacement of the lens unit 113. Therefore, the horizontal viewing angle and the vertical viewing angle of the lens 114 become wider on the basis of the replacement of the lens unit 113. The extended mask area 1502 corresponds to a difference area between the first image capturing executable area 1500 and the second image capturing executable area 1501.

As described above, when the lens unit 113 is replaced and the viewing angle of the lens 114 is increased, the extension determination unit 307 determines that the image capturing executable area is extended. Then, the extended mask setting unit 308 sets the extended mask area 1502 as the viewing angle difference area. The viewing angle difference area is a difference area between the image capturing executable area before the replacement of the lens unit 113 and the image capturing executable area after the replacement of the lens unit 113. That is, according to the present embodiment, the entire viewing angle difference area is set as the extended mask area 1502 where the browsing is restricted. The mask area is relatively enlarged with respect to the real space. Therefore, even in a case where the image capturing executable area is extended, the monitoring camera 100 can reduce the risk of browsing the area where the browsing should be restricted, and it is possible to appropriately set the area where the browsing is restricted. In addition, it is possible to save the work for the administrator or the like to set the area where the browsing is restricted again.

### Third Embodiment

According to the first embodiment, when the wide-angle lens 114 is replaced, the external border of the extended mask area is extended. However, the external border of the extended mask area may be extended when the focal length of the lens 114 is changed. It should be noted that descriptions of aspects similar to the first embodiment will be omitted.

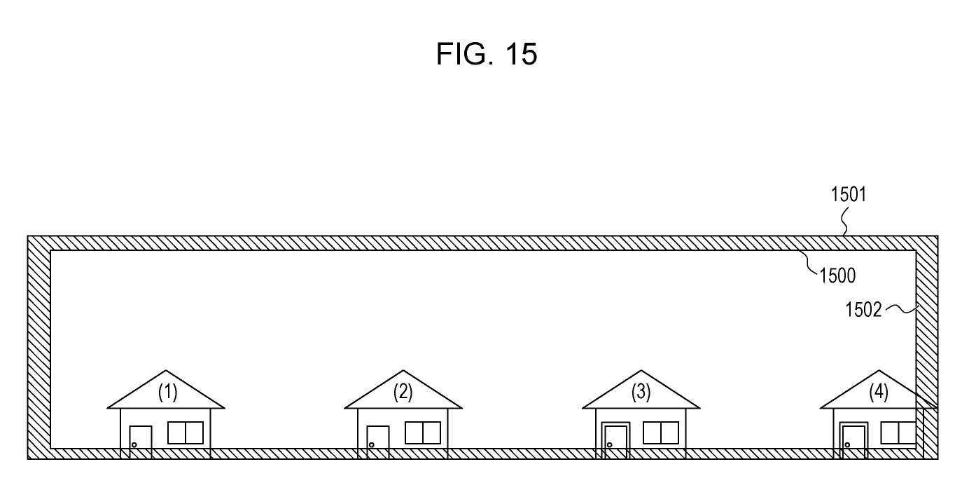

First, the mask setting event processing will be described with reference to FIG. 16. FIG. 16 is a flow chart of the mask setting event processing. The mask setting event processing is processing of the monitoring camera 100 performed when the mask setting unit 300 receives the mask setting command including the mask setting value from the client apparatus 200 and saves the mask setting value in the storage device 107B.

In step S1600, the obtaining unit 301 obtains the focal length of the lens 114 in the lens unit 113 currently mounted to the main body part 120. Then, the obtaining unit 301 saves the obtained focal length in the storage device 107B as the focal length of the lens 114 at the time of the mask setting.

In step S1601, the obtaining unit 301 obtains the current pan angle and tilt angle. Then, the area calculation unit 302 calculates the video area 401 at the time of the mask setting from the pan angle, the tilt angle, and the focal length obtained by the obtaining unit 301 to be saved in the storage device 107B. The video area 401 at the time of the mask setting according to the present embodiment is an example of the captured area.

In step S1602, the area calculation unit 302 calculates the mask area 402 from the video area 401 at the time of the mask setting calculated in step S1601 and the mask setting value received by the mask setting unit 300 and saves the calculated mask area 402 in the storage device 107B. The area calculation unit 302 assigns numbers starting from 0 to the respective external borders of the mask areas 402. Even when a plurality of the mask areas 402 exist, the area calculation unit 302, the numbers of the respective external borders of the mask areas 402 are set so as not to have a duplication. The external border of the mask area 402 to which a number n is assigned is referred to as an n-th border.

In step S1603, the extended mask setting unit 308 sets the extended mask area so as to represent the same area as the mask area calculated in step S603. The border of the extended mask area overlapped with the n-th border of the mask area will be also referred to as the n-th border of the extended mask area.

In step S1604, the end part determination unit 303 performs the start processing of the extension flag setting processing corresponding to the loop processing. Since the detail of the start processing of the extension flag setting processing is similar to step S605 of FIG. 6, descriptions thereof will be omitted.

In step S1605, the end part determination unit 303 determines whether or not the i-th border of the mask area 402 is overlapped with any one of the external borders of the video area 401 at the time of the mask setting. When the i-th border is overlapped with any one of the external borders, the end part determination unit 303 proceeds the processing to step S1606. When the i-th border is not overlapped with any one of the external borders, the end part determination unit 303 proceeds the processing to step S1607.

In step S1606, the end part determination unit 303 sets the i-th border extension flag as ON.

In step S1607, the end part determination unit 303 sets the i-th border extension flag as OFF.

In step S1608, the end part determination unit 303 performs the loop end processing of the extension flag setting processing corresponding to the loop processing. That is, the end part determination unit 303 returns the processing to step S1604.

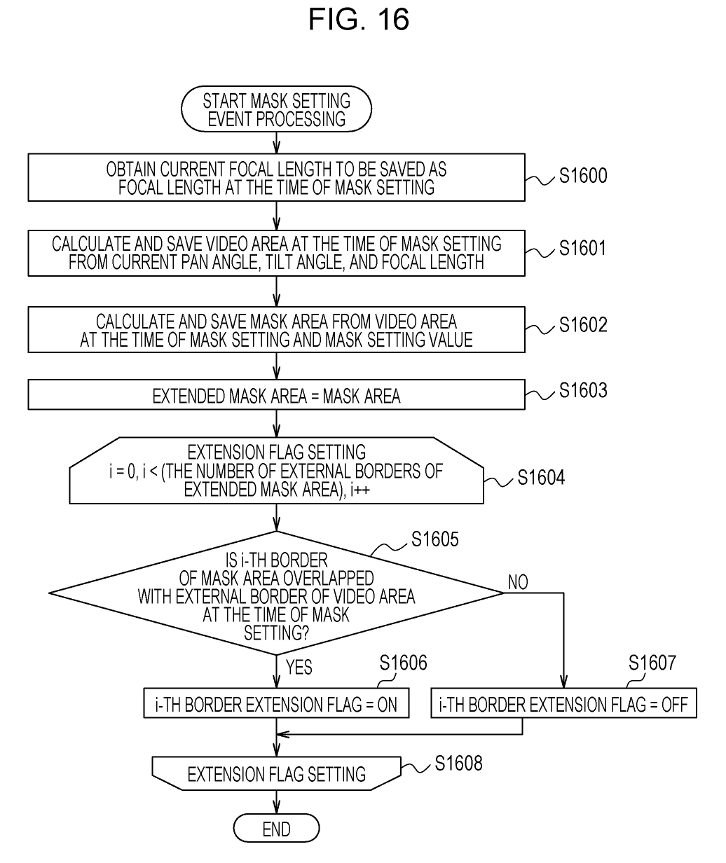

Next, with reference to FIG. 17, focal length change event processing will be described. FIG. 17 is a flow chart of the focal length change event processing. The focal length change event processing is processing executed when the detection unit 306 detects the change in the focal length of the lens 114.

In step S1700, the obtaining unit 301 obtains the focal length, the pan angle, and the tilt angle of the lens 114 in the lens unit 113 currently mounted to the main body part 120.

In step S1701, the extension determination unit 307 determines whether or not the video area 401 is extended. That is, the extension determination unit 307 compares the current focal length of the lens 114 obtained in step S1700 with the focal length of the lens 114 at the time of the mask setting. When the current focal length of the lens 114 is shorter than the focal length of the lens 114 at the time of the mask setting, the extension determination unit 307 determines that the video area 401 is extended. When it is determined that the video area 401 is extended, the extension determination unit 307 proceeds the processing to step S1702, and when it is determined that the video area 401 is not extended, the focal length change event processing of FIG. 17 is ended.

In step S1702, the area calculation unit 302 calculates the current video area 401 from the current pan angle, tilt angle, and focal length obtained by the obtaining unit 301.

In step S1703, the extension determination unit 307 performs the start processing of the extension processing corresponding to the loop processing. Since the detail of the start processing of the extension processing is similar to step S802 of FIG. 8, descriptions thereof will be omitted.

In step S1704, the extension determination unit 307 determines whether or not the i-th border extension flag is ON. When the i-th border extension flag is ON, the extension determination unit 307 proceeds the processing to step S1705, and when the i-th border extension flag is OFF, the extension determination unit 307 proceeds the processing to step S1706.

In step S1705, the extended mask setting unit 308 extends the i-th border of the extended mask area to an end part of the video area 401 after the extension corresponding to the i-th border. The video area 401 after the extension is the area calculated in step S1702. The end part of the video area 401 corresponding to the i-th border of the extended mask area is the end part of the video area 401 on the same side as the i-th border of the extended mask area as viewed from the center part of the extended mask area. For example, when the i-th border of the extended mask area is the right border, the end part of the video area 401 corresponding to the right border of the extended mask area becomes the right border of the video area 401.

In step S1706, the extension determination unit 307 performs the loop end processing of the extension processing corresponding to the loop processing. That is, the extension determination unit 307 returns the processing to step S1703.

As described above, when the current focal length of the lens 114 is shorter than the focal length of the lens 114 at the time of the mask setting, the extension determination unit 307 determines that the video area 401 is extended. If the mask area 402 is set and also the video area 401 is extended, the extended mask setting unit 308 extends the extended mask area and relatively extends the area where the browsing is restricted with respect to the real space. Therefore, even in a case where the video area 401 is extended, the monitoring camera 100 can appropriately set the area where the browsing is restricted, and it is possible to reduce the risk of browsing the area where the browsing should be restricted. In addition, it is possible to save the work for the administrator or the like to set the area where the browsing is restricted again.

### Fourth Embodiment

According to the second embodiment, the case has been described in which the viewing angle difference area of the lens 114 before and after the replacement is set as the mask area when the replacement with the wide-angle lens 114 is performed. However, when a change for shortening the focal length of the lens 114 is performed, an area corresponding to a difference between the focal length at the time of the activation of the monitoring camera 100 and the viewing angle after the change of the focal length may be set as the mask area. The monitoring camera system 1 that takes this aspect into account will be described below. It should be noted that descriptions of aspects similar to the second embodiment will be omitted.

First, functions of the monitoring camera 100 according to the present embodiment will be described. The monitoring camera 100 is further provided with an activation processing unit as the function. The activation processing unit executes activation event processing when the monitoring camera 100 is activated.

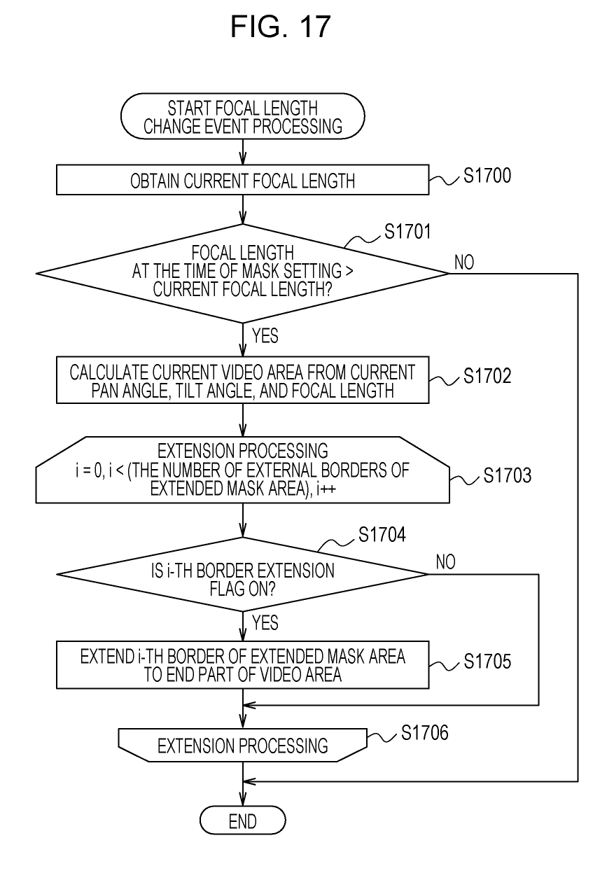

Next, activation event processing will be described with reference to FIG. 18. FIG. 18 is a flow chart of the activation event processing. The activation event processing is executed when the activation processing unit performs the processing.

In step S1800, the obtaining unit 301 obtains the focal length of the lens 114 in the lens unit 113 currently mounted to the main body part 120. Then, the obtaining unit 301 saves the obtained focal length in the storage device 107B as the focal length of the lens 114 at the time of the activation.

In step S1801, the extended mask setting unit 308 sets the extended mask area as invalid.

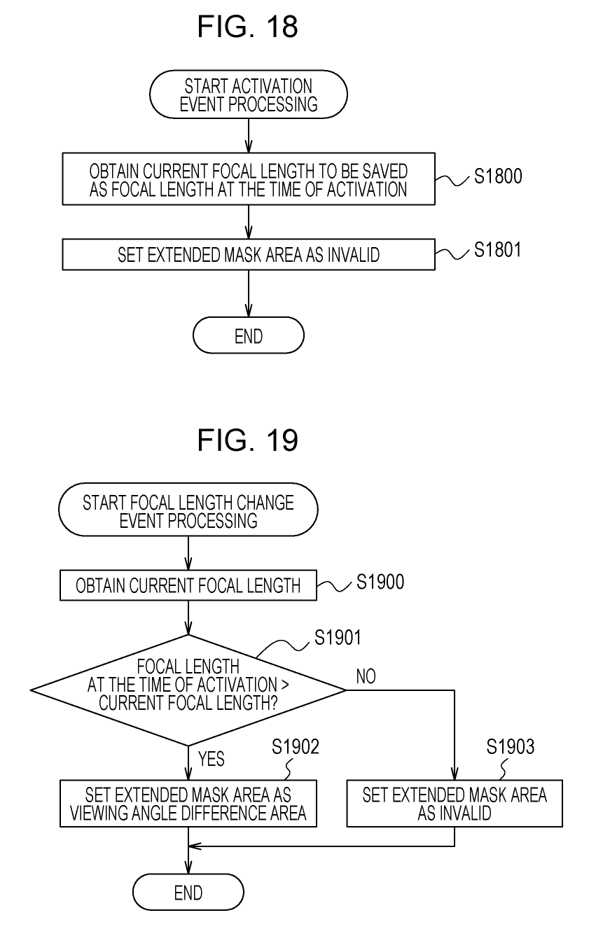

Next, the focal length change event processing will be described with reference to FIG. 19. FIG. 19 is a flow chart of the focal length change event processing. The focal length change event processing is processing executed when the detection unit 306 detects the change in the focal length of the lens 114.

In step S1900, the obtaining unit 301 obtains the focal length of the lens 114 in the lens unit 113 currently mounted to the main body part 120.

In step S1901, the extension determination unit 307 determines whether or not the video area 401 is extended. That is, the extension determination unit 307 compares the current focal length of the lens 114 obtained in step S1900 with the focal length of the lens 114 at the time of the activation. When the current focal length of the lens 114 is shorter than the focal length of the lens 114 at the time of the activation, the extension determination unit 307 determines that the video area 401 is extended. When it is determined that the video area 401 is extended, the extension determination unit 307 proceeds the processing to step S1902. When it is determined that the video area 401 is not extended, the extension determination unit 307 proceeds the processing to step S1903.

In step S1902, the extended mask setting unit 308 sets the extended mask area as the viewing angle difference area corresponding to the difference area between the video area 401 before the replacement of the lens unit 113 and the video area 401 after the replacement of the lens unit 113.

In step S1903, the extended mask setting unit 308 sets the extended mask area as invalid.

As described above, when the current focal length of the lens 114 is shorter than the focal length of the lens 114 at the time of the activation, the extension determination unit 307 determines that the video area 401 is extended. Then, the extended mask setting unit 308 sets the extended mask area as the viewing angle difference area. The viewing angle difference area is the difference area between the video area 401 before the replacement of the lens unit 113 and the video area 401 after the replacement of the lens unit 113. That is, the entire viewing angle difference area is set as the area where the browsing is restricted. Therefore, even in a case where the video area 401 is extended, the monitoring camera 100 can reduce the risk of browsing the area where the browsing should be restricted, and it is possible to appropriately set the area where the browsing is restricted. In addition, it is possible to save the work for the administrator or the like to set the area where the browsing is restricted again.

### Other Embodiments

The monitoring camera 100 according to the above-described respective embodiments is provided with the pan driving unit 111 and the tilt driving unit 112. However, a configuration may be adopted in which the monitoring camera 100 is not provided with at least one of the pan driving unit 111 and the tilt driving unit 112.

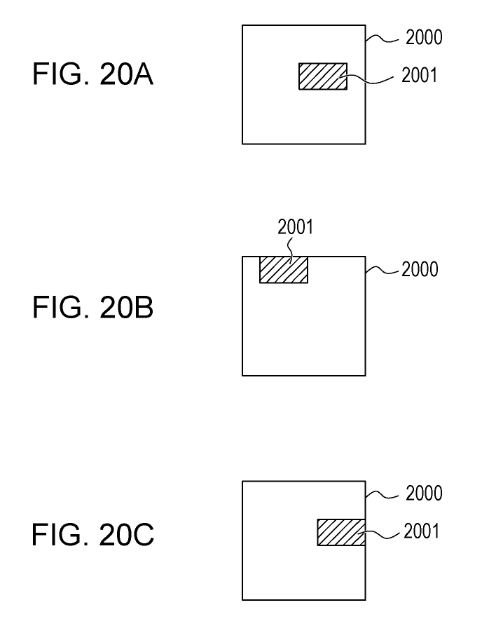

Here, the stationary monitoring camera 100 that is not provided with the pan driving unit 111 and the tilt driving unit 112 will be described with reference to FIGS. 20A to 20C. FIGS. 20A, 20B, and 20C illustrate a pattern of a video area 2000 and a mask area 2001 in the stationary monitoring camera 100.

First, a relationship between the video area 2000 and the image capturing executable area in the stationary monitoring camera 100 will be described. When the lens driving unit 115 of the monitoring camera 100 sets the focal length of the lens 114 to be the minimum, the viewing angle of the lens 114 becomes the maximum, and the video area 2000 is equal to the image capturing executable area. On the other hand, when the focal length of the lens 114 is not the minimum, the video area 2000 is smaller than the image capturing executable area. In FIGS. 20A, 20B, and 20C, it is set that the focal length of the lens 114 is the minimum, and the video area 2000 is equal to the image capturing executable area.

In the example of FIG. 20A, the external border of the mask area 2001 is not overlapped with the external border of the video area 2000. Therefore, the external border of the mask area 2001 is not overlapped with the external border of the image capturing executable area.

In the example of FIG. 20B, the top border of the mask area 2001 is overlapped with the top border of the video area 2000. Therefore, the top border of the mask area 2001 is overlapped with the top border of the image capturing executable area.

In the example of FIG. 20C, the right border of the mask area 2001 is overlapped with the right border of the video area 2000. Therefore, the right border of the mask area 2001 is overlapped with the right border of the image capturing executable area.

The above-described respective embodiments can also be applied to the stationary monitoring camera 100 on the basis of the above-described concept.

In addition, according to the first embodiment and the third embodiment, it is determined whether or not the extension flag is set as ON and the extended mask area is extended depending on whether or not the external border of the mask area is overlapped with the image capturing executable area 400 at the time of the mask setting or the external border of the video area 401. However, it may also be determined whether or not the extension flag is set as ON and the extended mask area is extended depending on whether or not a distance between an apex of the mask area and the image capturing executable area 400 at the time of the mask setting or the external border of the video area 401 is shorter than or equal to a predetermined distance. At this time, for example, the extension flag with regard to the external border including the apex of the mask area in which the distance with the image capturing executable area 400 at the time of the mask setting or the external border of the video area 401 becomes the predetermined distance is set as ON. In addition, it may be determined whether or not the extension flag is set as ON and the extended mask area is extended depending on whether or not a distance between the external border of the mask area and the image capturing executable area 400 at the time of the mask setting or the external border of the video area 401 is shorter than or equal to a predetermined distance.

As a result, even when the mask setting in which the external border of the mask area is not strictly overlapped with the image capturing executable area 400 or the external border of the video area 401 is performed, in a case where the image capturing executable area 400 or the video area 401 is extended, the monitoring camera 100 can appropriately set the area where the browsing is restricted.

In addition, it may be determined whether or not the extension flag is set as ON and the extended mask area is extended depending on whether or not the apex of the mask area is overlapped with the image capturing executable area 400 at the time of the mask setting or the external border of the video area 401.

According to the above-described respective embodiments, the image having a high transmittance is used as the extended mask image of the restricted image for the administrator. However, an image in which the extended mask area is represented by a closing line may be used as the extended mask image. In this case, the inside of the closing line can be browsed without the restriction.

The mask area and the extended mask area according to the above-described respective embodiments are respectively examples of restricted areas where the browsing in the captured image is restricted.

The process of overlapping the mask image and the extended mask image on the mask area and the extended mask area of the captured image is an example of the process of browsing the restricted area in the captured image. Process of decreasing the image quality of the restricted area, process of performing filter processing on the restricted area, process of applying mosaic to the restricted area, and the like may be performed as the process of browsing the restricted area in the captured image.

When the end part determination unit 303 determines whether or not the external border of the mask area 402 is overlapped with the external border of the image capturing executable area 400 in step S607 of FIG. 6 and step S1605 of FIG. 16, it can be mentioned that the following determination is performed. That is, it can be mentioned that it is determined whether or not the external border of the mask area 402 overlapped with the external border of the image capturing executable area 400 exists. This determination is an example of the determination on whether or not an extended end part corresponding to the end part of the restricted area exists in which the distance with the end part of the captured area before the extension is shorter than the predetermined distance. The external border of the mask area 402 overlapped with the external border of the image capturing executable area 400 is an example of the extended end part.

The external border of the mask area 402 and the external border of the image capturing executable area 400 are respectively examples of a boundary of the mask area 402 and a boundary of the image capturing executable area 400. These boundaries do not necessarily need to be straight lines and may be curved lines.

Embodiments can also be realized by processing in which a program for realizing one or more functions of the above-described embodiment is supplied to a system or an apparatus via a network or a storage medium, and one or more processors in a computer in the system or the apparatus reads out and executes the program. In addition, embodiments can be realized by a circuit (for example, an application specific integrated circuit (ASIC)) that realizes one or more functions.

The present invention has been described above by way of the embodiments, but the above-described embodiments are merely specific examples for carrying out the present invention, and the technical scope of the present invention should not be construed in a limited manner by the embodiments. That is, the present invention can be carried out in various modes without departing from the technical concept or main features of the present invention.

According to the above-described respective embodiments, even in a case where the image capturing area is extended, it is possible to appropriately set the area where the browsing is restricted.

Embodiment(s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to embodiments, it is to be understood that the invention is not limited to the disclosed embodiments. The scope of the following claims is to be accorded the broadest interpretation so as to encompass all such modifications and equivalent structures and functions.

This application claims the benefit of Japanese Patent Application No. 2016-134484 filed Jul. 6, 2016, which is hereby incorporated by reference herein in its entirety.

What is claimed is:

1. An image capturing apparatus comprising:
a setting unit configured to set a range of a restricted area where browsing is restricted in an image captured by an image capturing unit that captures an image formed by a lens; and
an extension unit configured to extend a size of the restricted area with respect to a real space in a manner that browsing of a second area in the real space, which includes a first area and also is wider than the first area, is restricted in a case where the restricted area where browsing of the first area in the real space is restricted is set by the setting unit and also an image capturing area where image capturing can be executed by the image capturing unit is extended.

2. The image capturing apparatus according to claim 1, further comprising:
a detection unit configured to detect replacement of the lens; and
an extension determination unit configured to determine that the image capturing area is extended when the detection unit detects the replacement of the lens and also a viewing angle of the lens after the replacement is higher than the viewing angle of the lens before the replacement,
wherein the extension unit extends a size of the restricted area with respect to the real space in a case where the setting unit sets the restricted area and also the extension determination unit determines that the image capturing area is extended.

3. The image capturing apparatus according to claim 1, further comprising an extension determination unit configured to determine that the image capturing area is extended when a focal length of the lens is shortened,
wherein the extension unit extends a size of the restricted area with respect to the real space in a case where the setting unit sets the restricted area and also the extension determination unit determines that the image capturing area is extended.

4. The image capturing apparatus according to claim 1, further comprising an end part determination unit configured to determine whether an extended end part having a distance with an end part of the image capturing area before the extension which is shorter than a predetermined length exists in an end part of the restricted area,
wherein the extension unit extends the extended end part of the restricted area to an end part corresponding to the extended end part in the image capturing area after the extension and extends the size of the restricted area with respect to the real space in a case where the setting unit sets the restricted area, the image capturing area where the image capturing is performed by the image capturing unit is extended, and also the end part determination unit determines that the extended end part exists.

5. The image capturing apparatus according to claim 4, wherein the end part determination unit sets a boundary, among boundaries of the restricted area, having a distance with a boundary of the image capturing area before the extension which is shorter than the predetermined distance as the extended end part.

6. The image capturing apparatus according to claim 4, wherein the end part determination unit sets a boundary, among boundaries of the restricted area, which is overlapped with a boundary of the image capturing area before the extension as the extended end part.

7. The image capturing apparatus according to claim 4, wherein the end part determination unit sets a boundary of the restricted area including an apex, among apices of the restricted area, having a distance with a boundary of the image capturing area before the extension which is shorter than the predetermined distance as the extended end part.

8. The image capturing apparatus according to claim 5, wherein the extension unit extends the boundary corresponding to the extended end part to the boundary of the image capturing area after the extension corresponding to the boundary of the image capturing area before the extension at the predetermined distance from the extended end part and extends the size of the restricted area with respect to the real space.

9. The image capturing apparatus according to claim 1, wherein the extension unit adds the image capturing area after the extension that is not included in the image capturing area before the extension to the restricted area and extends the size of the restricted area with respect to the real space.

10. The image capturing apparatus according to claim 1, further comprising a driving unit configured to perform driving so as to change an image capturing direction by changing at least one of a pan angle and a tilt angle,
wherein the image capturing area includes an entire area where the image capturing unit is configured to perform the image capturing by the driving by the driving unit.

11. The image capturing apparatus according to claim 1,
wherein the lens is configured to change a focal length of the lens, and
wherein the image capturing area includes an entire area where the image capturing unit is configured to perform the image capturing when the focal length of the lens is minimum.

12. The image capturing apparatus according to claim 1, wherein the image capturing area is an area where the image capturing unit is configured to perform the image capturing in a state in which a pan angle and a tilt angle are at arbitrary positions and a focal length of the lens is arbitrary.

13. The image capturing apparatus according to claim 1, further comprising a generation unit configured to generate a restricted image where browsing of the restricted area in the captured image is restricted.

14. The image capturing apparatus according to claim 13, wherein the generation unit generates the restricted image by performing any one of process of applying a mask to the restricted area, process of decreasing an image quality of the restricted area, process of performing filter processing on the restricted area, and process of applying mosaic to the restricted area with respect to the restricted area in the captured image.

15. The image capturing apparatus according to claim 13, further comprising a transmission unit configured to transmit the restricted image generated by the generation unit to an external apparatus.

16. The image capturing apparatus according to claim 13, wherein the generation unit is a first generation unit, the image capturing apparatus further comprising a second generation unit configured to generate a second restricted image where browsing of the restricted area before the extension by the extension unit in the captured image is restricted after the image capturing area is extended and browsing of a difference area between the restricted area before the extension and the restricted area after the extension can be performed.

17. The image capturing apparatus according to claim 16, wherein the generation unit generates the second restricted image by performing process of applying a transmissive mask to the difference area or process of representing an edge of the difference area by a closing line.

18. The image capturing apparatus according to claim 16, further comprising a second transmission unit configured to transmit the second restricted image generated by the second generation unit to an external apparatus for a user who has a predetermined authority.

19. A control method for an image capturing apparatus, the control method comprising:
setting a range of a restricted area where browsing is restricted in an image captured by an image capturing unit that captures an image formed by a lens; and
extending a size of the restricted area with respect to a real space in a manner that browsing of a second area in the real space, which includes a first area and also is wider than the first area, is restricted in a case where the restricted area where browsing of the first area in the real space is restricted is set and also an image capturing area where image capturing can be executed by the image capturing unit is extended.

20. A non-transitory computer-readable recording medium storing a program for causing an image capturing apparatus to perform a control method, the control method comprising:
setting a range of a restricted area where browsing is restricted in an image captured by an image capturing unit that captures an image formed by a lens; and
extending a size of the restricted area with respect to a real space in a manner that browsing of a second area in the real space, which includes a first area and also is wider than the first area, is restricted in a case where the restricted area where browsing of the first area in the real space is restricted is set and also an image capturing area where image capturing can be executed by the image capturing unit is extended.
